(19) United States
(12) Patent Application Publication
(10) Pub. No.: US 2006/0026337 A1
(43) Pub. Date: Feb. 2, 2006

(54) Method increasing seeking speed when accessing file stored in storage device, machine-readable medium thereof, and related apparatus

(76) Inventor: Chia-Jung Hsu, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 11/161,126

(22) Filed: Jul. 24, 2005

Related U.S. Application Data
(60) Provisional application No. 60/521,983, filed on Jul. 30, 2004.

(30) Foreign Application Priority Data
Dec. 16, 2004 (TW) 093139229

(51) Int. Cl. G06F 12/14

(52) U.S. Cl. 711/100

(57) ABSTRACT

A method for accessing a file stored in a plurality of storage blocks of a storage device is disclosed. Each of the plurality of storage blocks of the storage device corresponds to an index value, and the plurality of the index values form a single direction chain. The method includes the following steps: (a) setting at least one break point according to the single direction chain formed by the plurality of the index values; and (b) accessing the file according to the at least one break point and the single direction chain formed by the plurality of the index values.

### CROSS REFERENCE TO RELATED APPLICATIONS

This application claims the benefit of U.S. Provisional Application No. 60/521,983, which was filed on Jul. 30, 2004 and entitled “Fast Seek Approach on FAT File System”.

### BACKGROUND

The present invention relates to file systems, and more particularly, to a method for accessing a file stored in a storage device that is organized by a file system, machine-readable medium thereof, and related apparatus.

Generally speaking, a file system is an interface virtually set between a processor and a storage device for organizing files and directories on the storage device. Through the intermediate file system, the processor stores data into the storage device or retrieves data from the storage device.

File allocation table file system (abbreviated as FAT file system) is a kind of widely applied file system, which is utilized by many kinds of electronic systems. Proposed in 1976 by Bill Gates of Microsoft, after decades of development, nowadays there are some different versions of the FAT file system. FAT 12 is a version of the FAT file system using 12 bits addressing; FAT 16 is a version of the FAT file system using 16 bits addressing; FAT 32 is a version of the FAT file system using 32 bits addressing.

The FAT file system divides a utilized storage device into storage blocks. The storage blocks are referred to as clusters. According to the specification of the FAT file system, every file must be stored in an integer number of clusters. Each cluster includes one or more than one sector and each sector has 512 bytes of storage space.

A disk map utilized by the FAT file system is called a “file allocation table” (abbreviated as FAT), which includes a plurality of FAT entries. For a storage device being divided into N clusters, a file allocation table corresponding to the storage device also has N FAT entries. More specifically, each FAT entry corresponds to a cluster. Different values have different meanings for a FAT entry. For example, if a value ‘0’ is contained in a FAT entry, it means that the cluster corresponding to the FAT entry is a free cluster, i.e. the cluster is free for storing a new file or a portion of a new file. If a value ‘−8’, . . . , or ‘−1’ is contained in a FAT entry, it means that the cluster corresponding to the FAT entry is an end of chain (abbreviated as EOC), i.e. the cluster is a last cluster of a cluster chain storing a file. If a value ‘−9’ is contained in a FAT entry, it means that the cluster corresponding to the FAT entry is a reserved cluster. If a FAT entry contains a value different from the above-mentioned specific values, the value represents a cluster serial number of a next cluster storing a subsequent part of a file stored by the cluster corresponding to the FAT entry.

When a file stored in the storage device occupies more than one cluster, a plurality of FAT entries corresponding to the sequentially occupied clusters form a FAT chain, which is a single direction chain. It can also be thought of as the clusters storing the file form a single direction cluster chain. For example, assume that a file is stored in the 3rd, 5th, 7th, 9th, 11th, and 13th clusters of the storage device in sequence. The 3rd, 5th, 7th, 9th, 11th, and 13th clusters form a cluster chain with single direction. The FAT entry corresponding to the 3rd cluster has a value 5, meaning that the cluster after the 3rd cluster in the cluster chain is the 5th cluster. The FAT entry corresponding to the 5th cluster has a value 7, meaning that the cluster after the 5th cluster in the cluster chain is the 7th cluster. Similarly, the FAT entries corresponding to the 7th, 9th, and 11th clusters have values 9, 11, and 13, respectively, meaning that the clusters after the 7th cluster in the cluster chain are the 9th, 11th, and 13th clusters in sequence. The FAT entry corresponding to the 13th cluster has a value ‘−8’, . . . , or ‘−1’, meaning that the 13th cluster is the last cluster in the cluster chain. In other words, the single direction FAT chain of the file begins with the FAT entry corresponding to the 3rd cluster, which is followed by the FAT entries corresponding to the 5th, 7th, 9th, 11th, and 13th clusters in sequence.

Since a FAT chain of a file stored in the storage device has a single direction characteristic, when accessing the file, a pointer is not allowed to jump from a byte location in a cluster directly to another byte location in another cluster in front of the currently accessed cluster in the cluster chain, except that the another cluster is the first cluster of the cluster chain. Please take the above-mentioned file occupying the 3rd, 5th, 7th, 9th, 11th, and 13th clusters in sequence as an example and assume each cluster has 512 bytes of storage space. When the 2500th byte of the file is accessed, the pointer points to an address of the 11th cluster. If the 1500th byte of the file, which is stored in a cluster in front of the 11th cluster in the cluster chain, is going to be accessed, the processor does not know which cluster is the exact cluster storing the 1500th byte of the file immediately. The only information at hand is that the next cluster of the 11th cluster in the cluster chain is the 13th cluster. No information at hand is about which clusters are in front of the 11th cluster in the cluster chain. The only way to jump to the 1500th byte of the file is to first find the first cluster of the cluster chain, which is the 3rd cluster. Next, use the FAT entry corresponding to the 3rd cluster, which has a value 5, to find a next cluster. Along the cluster chain, the 5th and 7th clusters are found, and the pointer can then be moved to the address of the 7th cluster storing the 1500th byte of the file.

The above-mentioned characteristics of the FAT file systems limits seeking speed for file accessing. Especially when a lot of jumping operations are required, reading the FAT chain might waste a lot of time. A new kind of method that increases seeking speed when accessing a file stored in a storage device that is organized by a FAT file system is therefore required.

### SUMMARY

An objective of the claimed invention is to provide a method for accessing a file stored in a storage device that is organized by a FAT file system to increase a seeking speed.

According to the claimed invention, a method for accessing a file stored in a plurality of storage blocks of a storage device is disclosed. Each of the storage blocks corresponds to an index value. The plurality of index values forms a chain. The method includes: (a) setting at least one break point for the file according to the chain formed by the index values; and (b) accessing the file according to the at least one break point and the chain formed by the index values.

The method of the claimed invention can also be recorded in any kind of storage media in a form of a program code. When the program code is loaded and executed by a machine, the machine becomes an apparatus implementing ideas of the claimed invention.

The claimed invention sets at least one break point for a file going to be accessed. With additional information provided by the break point(s), seeking speed when accessing the file is increased.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an exemplary flowchart illustrating the method of the present invention.

FIG. 2 shows an exemplary file and how break points are set for the file according to the present invention.

FIG. 3 shows a block diagram of an apparatus according to an embodiment of the present invention.

### DETAILED DESCRIPTION

An idea of the present invention is applied in a file system, and relates to set break point(s) for a file to be accessed. Using the break points as an auxiliary tool when accessing the file, seeking speed is increased.

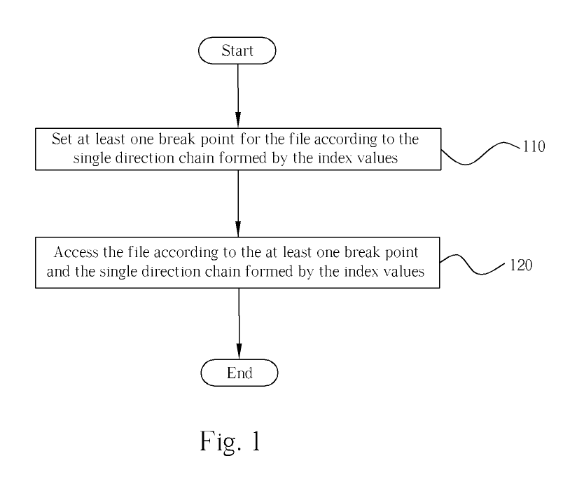

FIG. 1 shows an exemplary flowchart illustrating the method of the present invention. The method is utilized by a processor for accessing a file stored in a plurality of storage blocks of a storage device, wherein the storage device is organized by a file system. Each of the storage blocks corresponding to an index value, and the plurality of index values corresponding to the plurality of storage blocks forms a single direction chain. In other words, it can also be thought of as the plurality of storage blocks forms a single direction chain. The steps shown in the flowchart of FIG. 1 are as follows:

Step 110: Set at least one break point for the file according to the single direction chain formed by the index values.

Step 120: Access the file according to the at least one break point and the single direction chain formed by the index values.

For instance, the file system organizing the storage device is a FAT file system. The FAT file system divides the storage device into clusters; each of the aforementioned storage blocks is one of the clusters of the storage device. Each of the index values is a FAT entry value corresponding to one of the clusters. Please take a look at an example for more detailed information on the method of the present invention. Assume that each cluster of the storage device has 512 bytes of storage space, and a file going to be accessed according to the method of FIG. 1 is stored in the 3rd, 5th, 7th, 9th, 11th, and 13th clusters of the storage device in sequence.

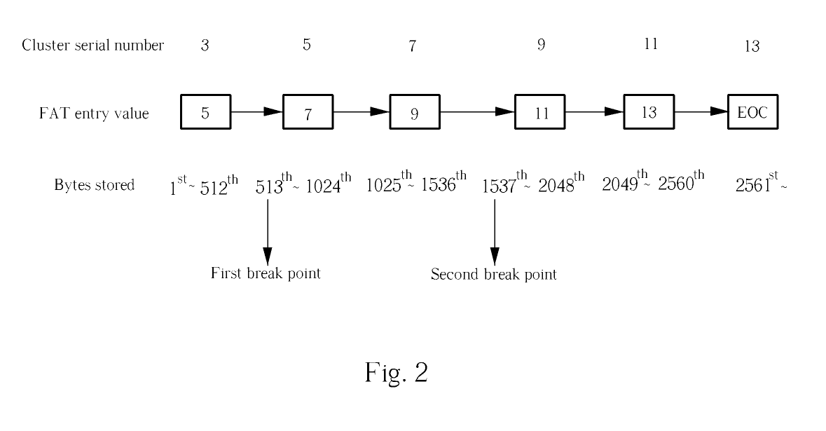

First, in step 110, before actually accessing the file, the processor can read the FAT chain of the file organized by the FAT file system. The FAT chain of the file starts from a FAT entry corresponding to the 3rd cluster of the storage device and ends in FAT entry corresponding to the 13th cluster of the storage device, to set at least one break point for the file accordingly. Each of the at least one break point(s) is related to a cluster serial number of a cluster storing a specific byte of the file. For example, two break points can be set for the file. FIG. 2 is a diagram illustrating how the two break points can be set for the file. A first break point can be set for representing that the 513th byte of the file is stored in the 5th cluster of the storage device. A second break point can be set for representing that the 1537th byte of the file is stored in the 9th cluster of the storage device.

Next, in step 120, the file is accessed according to the break points set in step 110 and the FAT chain of the file. Take a look at some situations. During the accessing process, if an accessing pointer is going to be moved from the 1st byte of the file to the 1537th byte of the file, the second break point can provide useful information. With the information provided by the second break point, it becomes apparent that the 1537th byte of the file is stored in the 9th cluster of the storage device. The accessing pointer can be directly moved to the starting address of the 9th cluster and reading the FAT chain of the file is not required. If the accessing pointer is going to be moved from the 1537th byte of the file to the 1100th byte of the file, the first break point can provide useful information. With the information provided by the first break point, the FAT chain reading process can be started from the FAT entry corresponding to the 5th cluster. According to the value of that entry, which is ‘7’ in this example, the accessing pointer can then be moved to the address of the 7th cluster storing the 1100th byte of the file. If the accessing pointer is going to be moved from the 1100th byte of the file to the 2564th byte of the file, the second break point can again provide useful information. With the information provided by the second break point, the FAT chain reading process can be started from the FAT entry corresponding to the 9th cluster. According to the values of that entry and subsequent entries, which are ‘11’ and ‘13’ in this example, the accessing pointer can then be moved to the address of the 13th cluster storing the 2564th byte of the file.

How to set the break point(s) in step 110 can be a design choice. For instance, for each file going to be accessed, a break point can be set for every 2048 bytes, i.e. the distance between each pair of adjacent break points is fixed as 2048 bytes. The break points can also be set to the most frequently accessed byte locations of the file according to the characteristics of the file. Besides, each break point is preferred to be set on, but not limited to, an address at the beginning part of a cluster. Using the above-mentioned file as an example, the first break point is set on an address, which is the address storing the 513th byte of the file, at the beginning of the 5th cluster. The second break point is set on an address, which is the address storing the 1537th byte of the file, at the beginning of the 9th cluster.

Please note that even though the FAT file system is used as an example, other kinds of file system having similar characteristics with the FAT file system can also apply the method of the present invention. With the ideas of the present invention, seeking speed when accessing a file is increased.

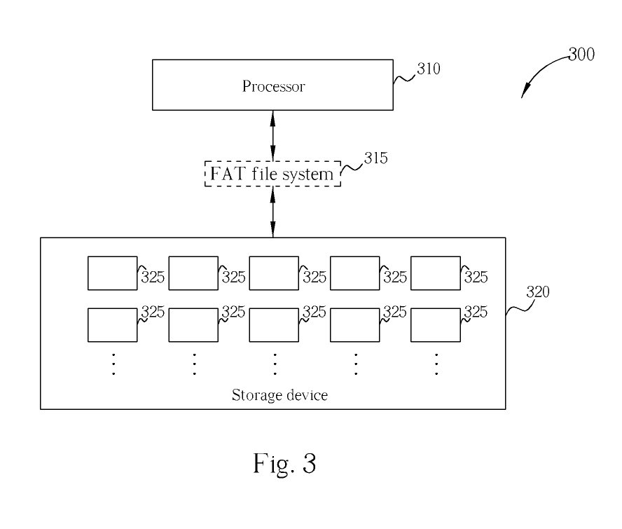

Please refer to FIG. 3, a block diagram of an apparatus according to an exemplary embodiment of the present invention is illustrated. In FIG. 3, an apparatus 300 includes a processor 310 and a storage device 320. A file system 315 is virtually set between the processor 310 and the storage device 320 as an interface for organizing files and directories on the storage device 320. The file system divides the storage device 320 into many storage blocks 325. A plurality of storage blocks 325 is used to store a file, and the processor 310 accesses the file according to the method of the present invention. Since the exact operations of the apparatus 300 can be easily understand according to the preceding paragraphs, further description is omitted here.

In addition, the method of the present invention can be recorded as a program code stored in any kind of physical storage media, such as floppy discs, optical discs, hard discs, or other kind of machine-readable storage media. When the program code for implementing the method of the present invention is executed by a machine, such as a computer, the machine become an apparatus implementing the method of the present invention. Besides, the method of the present invention can also be represented by a program code and transmitted through any kind of communication channel, such as electrical wires, cables, optical fibers, or even wireless communication channels. When the program code for implementing the method of the present invention is received, loaded, and executed by a machine, such as a computer, the machine become an apparatus implementing the method of the present invention. While the program code is combined with a processor, the processor becomes a unique apparatus implementing the method of the present invention.

In contrast to the prior art, the present invention sets at least one break point for a file going to be accessed. With additional information provided by the break point(s), seeking speed when accessing the file is increased. Especially when many pointer-jumping operations are required, the advantage of increased speed becomes more conspicuously.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for accessing a file stored in a plurality of storage blocks of a storage device, each of the storage blocks corresponding to an index value, the plurality of index values forming a chain, the method comprising:
(a) setting at least one break point for the file according to the chain formed by the index values; and
(b) accessing the file according to the at least one break point and the chain formed by the index values.

2. The method of claim 1, wherein the chain is a single direction chain.

3. The method of claim 2, wherein step (a) further comprises:
according to the single direction chain formed by the index values, setting an index value corresponding to a storage block storing a specific byte of the file as a break point.

4. The method of claim 2, wherein step (b) further comprises:
for jumping from a first byte of the file to a second byte of the file, reading index values along the single direct chain from a break point set in front of the second byte until an index value corresponding to a storage block storing the second byte is determined.

5. The method of claim 1, wherein the storage device is organized by an FAT file system.

6. An apparatus, comprising:
a storage device comprising a plurality of storage blocks for storing a file, wherein each of the storage blocks corresponds to an index value, the plurality of index values forms a chain; and
a processor electrically connected to the storage device, for setting at least one break point for the file according to the chain formed by the index values, and accessing the file according to the at least one break point and the chain formed by the index values.

7. The apparatus of claim 6, wherein the chain is a single direction chain.

8. The apparatus of claim 7, wherein the processor sets an index value corresponding to a storage block storing a specific byte of the file as a break point according to the single direction chain formed by the index values.

9. The apparatus of claim 7, wherein for jumping from a first byte of the file to a second byte of the file, the processor reads index values along the single direct chain from a break point set in front of the second byte until an index value corresponding to a storage block storing the second byte is determined.

10. The apparatus of claim 6, wherein the storage device is organized by an FAT file system.

11. A machine-readable medium storing a computer program which when executed by a processor enables the processor to perform a method to access a file stored in a plurality of storage blocks of a storage device, , each of the storage blocks corresponding to an index value, the plurality of index values forming a chain, the method comprising:
(a) setting at least one break point for the file according to the chain formed by the index values; and
(b) accessing the file according to the at least one break point and the chain formed by the index values.
